(19) United States
(12) Patent Application Publication
(10) Pub. No.: US 2006/0174255 A1
(43) Pub. Date: Aug. 3, 2006

(54) Apparatus for positioning clamper of optical disc device

(75) Inventor: Chih Chong Chuo, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/119,878

(22) Filed: May 3, 2005

(30) Foreign Application Priority Data
Feb. 3, 2005 (TW) 094103395

(51) Int. Cl. G11B 17/028; G11B 19/20; G11B 17/03

(52) U.S. Cl. 720/706

(57) ABSTRACT

An apparatus for positioning a damper of an optical disc device includes a base plate installed above a spindle motor of the disc device, a holding plate pivoted on the base plate, an elastic member, and a clamper, in which a flexible pressing plate and a pair of flexible supporting plates at the same plane are respectively extended from the holding plate. An arc-shaped holding groove used for holding the damper is disposed at the inner flank side of each supporting plate, and the holding groove is provided with an inward inclined wall to allow the damper to be guided and positioned in the holding grooves. And, a downward force is applied on the surface of the pressing plate by the elastic member so that the pressing plate is pressed on the upper of the damper and the damper is fixedly positioned in the holding grooves. Thereby, the damper would not result noise due to the external shaking and the turntable can be engaged accurately with the clamper.

This Non-provisional application claims priority under 35 U.S.C. Republic of China on Jan. 3, 2005, the entire contents of which are thereby incorporated by reference.

### FIELD OF THE INVENTION

The present invention relates to an apparatus for positioning a damper of an optical disc device, particular to an apparatus for positioning a damper of an optical disc device which can effective to position a damper without resulting noise due to external shaking.

### BACKGROUND OF THE INVENTION

In conventional optical disc devices, to position a disc on a turntable is mainly classified into the following two types: (1) a pawl-positioning type by providing pawls on the center of a turntable to fix a disc on it, which is usually found in a slim type optical disc device; (2) a clamper-positioning type by pressing a disc on the turntable through the clamper, which is usually found in half height type and slot-in type optical disc devices. Regarding the clamper-positioning type, as shown in FIGS. 1a and 1b, it mainly includes a holding plate B having a central hole H which is installed above a spindle motor M, and a magnetic circle damper C which covers on the central hole H. The damper C also has a central hole C1 at its lower surface and the spindle motor M is provided with a camshaft M1 which associates with the central hole C1 to hold the disc D between the damper C and a turntable M2 provided above the spindle motor M. When a disc-loading mechanism (not shown in the Figures) of the optical disc device loads the disc D to the position above the spindle motor M, the spindle motor M lifts up to allow the camshaft M1 of the spindle motor M being engaged with the central hole C1 of the damper C. In this time, since the damper C is magnetic and would magnetize onto the turntable M2 holding the disc D between them. Subsequently, the spindle motor M drives the turntable M2 spinning and then the disc D spins too. And then, an optical pick-up unit (not shown in the Figures) reads the information recorded on the disc D. Although the damper C could effectively hold the disc D between the damper C and the turntable M2 of the spindle motor M in the conventional optical disc device, however, the assembling position of the camshaft M1 of the spindle motor M is possible deviated due to tolerances t1 and t2 which is generated in assembling or producing procedures. Therefore, to engage the damper C accurately with the camshaft M1 of the spindle motor M, the diameter of the central hole H is larger than that of a neck part C2 of the magnetic damper C to provide an adjusting space of the damper C. If the tolerances t1 or t2 of the spindle motor M are generated during its assembling, the damper C would move in adjusting space provided by the central hole H to aim at the camshaft M1 and allow the camshaft M1 engaging accurately with the central hole C1 of the damper C when the spindle motor M lifts up. Thus the damper C magnetizes onto the turntable M2 smoothly and clamps the disc D between them.

However, in the case of that no disc is loaded in the device, since the diameter of the central hole H is larger than that of the neck part C2, the damper C is moveable in the device. Moreover, if the optical disc device is provided in a car, the damper C would shake and attack the side wall of the central hole H due to the external shaking when the car is moving, and it may result noise. Besides, if the spindle motor M is deviated in one direction, for example the right direction in FIG. 1a, during assembling meanwhile the damper C is deviated in the central hole H in the direction opposite to the spindle motor deviation direction, for example the left direction in FIG. 1a, there occurs a maximum clearance between the central hole C1 of the damper C and the camshaft M1 of the spindle motor M. In this time, when the spindle motor M lifts up, it has a possibility that the damper C is failed to move to the position where the central hole C1 aims the camshaft M1 and could not clamp the disc D with the turntable M2 since the maximum clearance between the central hole C1 and the camshaft M1 exceeds the allowable deviation margin. To ensure the camshaft M1 of the spindle motor M to be engaged accurately with the central hole C1 regardless of the deviation direction of the central hole C1 relative to the central hole H, it should consider the deviation tolerance of the damper C and thus the available assembling tolerance of the spindle motor M is reduced, i.e. it requires a finer precision, it therefore increases the cost and time required to assemble the device.

Accordingly, the present invention is intended to provide an apparatus for positioning a damper of an optical disc device which can keep the damper in a non-clamping position when no disc is carried. According to the present apparatus, it can accurately hold a disc between the damper and the turntable and provide a wide assembling tolerance to the spindle motor.

### SUMMARY OF THE INVENTION

The object of the present invention is to provide an apparatus for positioning a damper of an optical disc device, which can position the damper in position when no disc is clamped so that the damper would not result noise due to the external shaking. Moreover, the apparatus of the present invention can provide a wide assembling tolerance to the spindle motor.

To achieve the above object, the present invention provides an apparatus for positioning a damper of an optical disc device, the apparatus is installed above a spindle motor and includes: a base plate on which a hole corresponding to the spindle motor is provided; a holding plate pivoted on the base plate, one end of the holding plate is extendedly provided with a flexible pressing plate and a pair of flexible supporting plates parallel to each other and the supporting plates are against the surface of the base plate and are positioned above the hole of the base plate; an elastic member, one end of which is fixed on the base plate and other end presses against the pressing plate to provide a downward force on it; and a damper provided with a circular plate, each of the flexible supporting plates has a holding groove. Thereby the circular plate is pressed by the pressing plate and held in the holding grooves when no disc is clamped therein.

According to the present apparatus for positioning a damper of an optical disc device, there is a gap between the pressing plate and the supporting plates. The supporting plates will be slight deformed due to against on the base plate and thus the gap will be slight decreased to allow the pressing plate to press firmly on the damper and keep the damper in position.

According to the present apparatus for positioning a damper of an optical disc device, one end of the elastic member is fixed on the base plate and the other end is designed to press on the pressing plate which in turn presses on the damper to keep the damper positioning in the holding groove of the supporting plates. Thereby, the camshaft could engage into the central hole of the damper when the spindle motor lifts up.

Moreover, when the spindle motor lifts up at a certain distance, the camshaft engages into the central hole of the damper and the damper is also lifted up, the pressing plate which already presses on the damper is also lifted up to allow the damper leaving the holding groove. Accordingly, the damper will press a disc on the turntable due to the press force attributed to the pressing plate and spin with the disc together with the rotation of the turntable.

After completing the playing, the spindle motor lowers down, the elastic member presses on the pressing plate and in turn on the damper to guide the damper into the holding groove.

### BRIEF DESCRIPTION OF DRAWINGS

The present invention is illustrated more detail by reference to the accompanying drawings, wherein:

FIG. 1a is a cross-section side-viewing drawing showing a conventional apparatus structure for positioning a clamper;

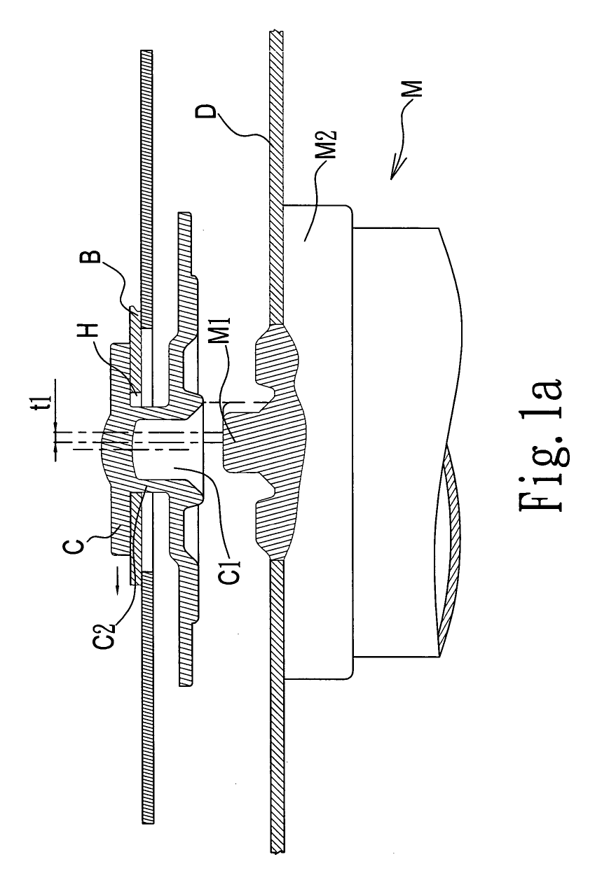

FIG. 1b is another cross-section side-viewing drawing showing a conventional apparatus structure for positioning a clamper;

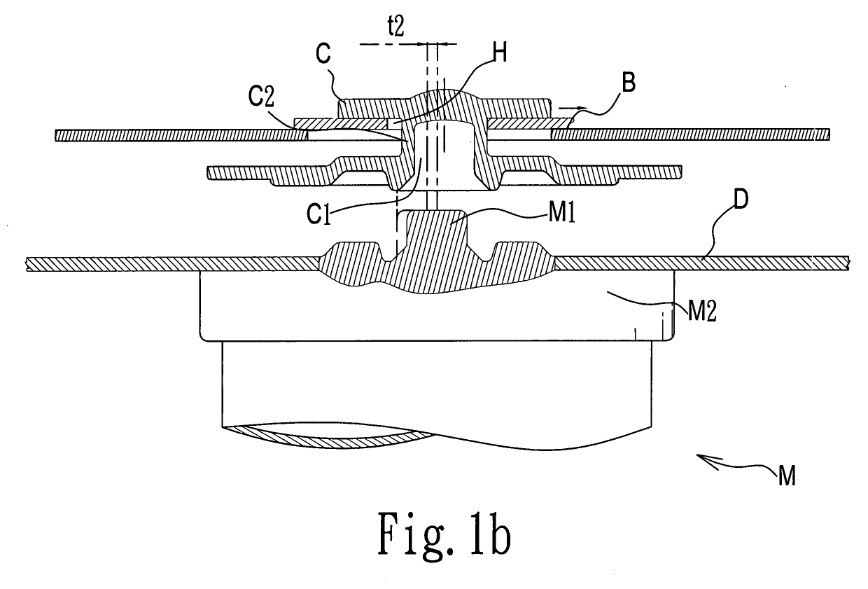

FIG. 2 is a schematic drawing showing the apparatus for positioning a damper of an optical device according to the present invention;

FIG. 3 is a cross-section side-viewing drawing of FIG. 2;

FIG. 4 is a cross-section side-viewing drawing showing the holding plate in the present apparatus which has not yet been assembled on base plate;

FIG. 5 is a cross-section side-viewing drawing showing the holding plate in the present apparatus which has been assembled on base plate;

FIG. 6 is a schematic drawing showing the present apparatus in which a disc has been loaded on the turntable but has not yet been clamped by the apparatus; and

FIG. 7 is a schematic drawing showing the present apparatus in which a disc has been loaded on the turntable and has already been clamped by the apparatus.

### DETAILED DESCRIPTION OF THE INVENTION

The present invention is illustrated in more detail by reference the following preferred embodiments which are only used for illustration without limiting the scope of the present invention.

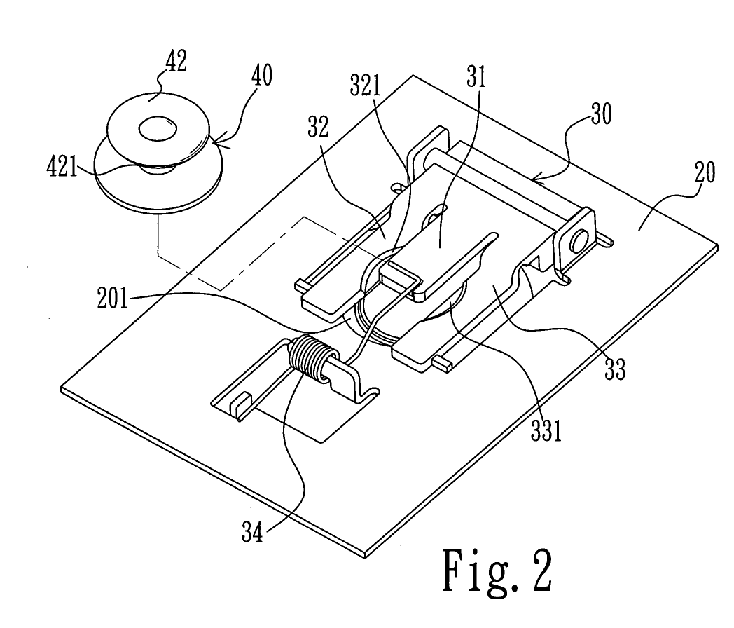

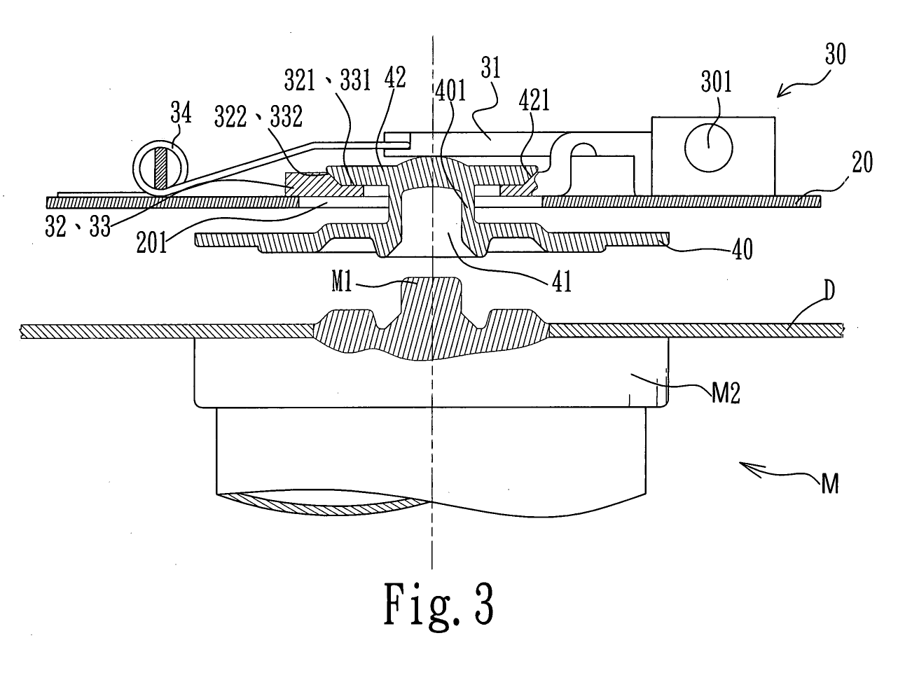

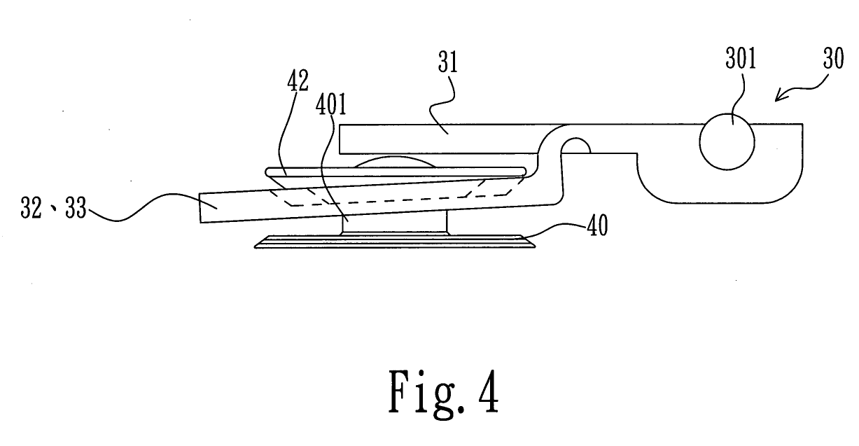

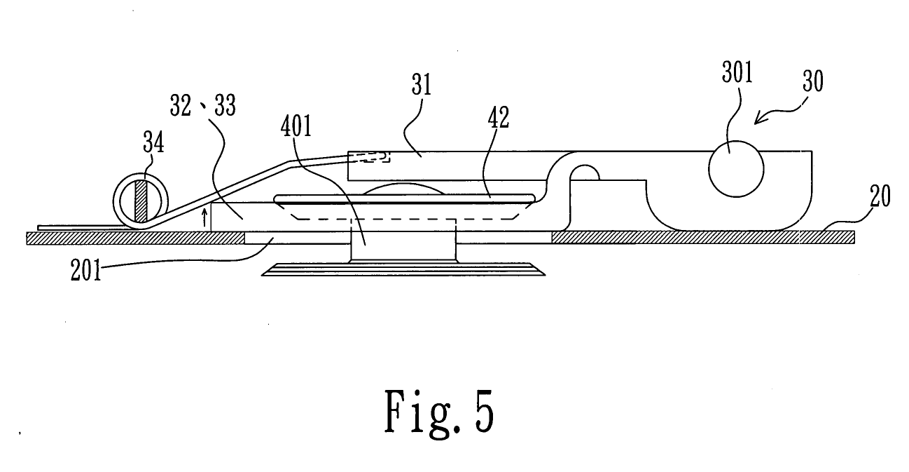

Please refer to FIGS. 2 to 5. FIG. 2 is a schematic drawing showing the apparatus for positioning a damper according to the present invention. FIG. 3 is a cross-section side-viewing drawing of FIG. 2. FIG. 4 is a cross-section side-viewing drawing showing the holding plate in the present apparatus which has not yet been assembled on base plate. FIG. 5 is a cross-section side-viewing drawing showing the holding plate in the present apparatus which has been assembled on base plate. As shown in FIG. 2, the present apparatus for positioning a damper of an optical disc device includes a base plate 20, a holding plate 30, a damper 40, and an elastic member 34, the optical disc device includes a spindle motor M for rotating the disc in which a turntable M2 and a camshaft M1 are further installed above the spindle motor M. In the present apparatus, the base plate 20 is installed above the spindle motor M and provided with a hole 201 positioned above the spindle motor M. The damper 40 is disposed through the hole 201 provided on the base plate 20 for clamping a disc with the turntable M2. One end of the holding plate 30 is fixed pivotally on the base plate 20 through a shaft 301. The other end of the holding plate 30 is extendedly provided with a pressing plate 31 and a pair of supporting plates 32 and 33 both of which are on the same plane and parallel to each other. There is a gap between the pressing plate 31 and the supporting plates 32, 33. The pressing plate 31 is horizontally extended and the supporting plates 32, 33 are horizontally downward extended slight lower than the pressing plate before assembling the holding plate on the base plate, as shown in FIG. 4. The holding plate 30 is positioned above the base plate 20 so that the supporting plates 32 and 33 are located above the base plate 20 and across the hole 201, as shown in FIG. 5. One end of the elastic member 34 is fixed on the base plate 20 and the other end presses on the pressing plate 31 and provides a downward force on the pressing plate 31. In this embodiment, the elastic member 34 is a torsion spring but not limited thereto.

As shown in FIGS. 4 and 5, in this embodiment, the supporting plate 32 and 33 are connected with the holding plate 30 through arc-shaped corners to give a gap between the pressing plate 31 and the supporting plates 32, 33. The arc-shaped comers are formed by bending the supporting plate down and then up respectively. The holding plate 30 is held on the base plate 20 through the downward force on the pressing plate 31 attributed to the elastic member 34.

Now please refer to FIGS. 2 and 3 again. In this embodiment, the supporting plates 32 and 33 are respectively provided with arc-shaped holding grooves 321 and 331 at its inner side facing each other, for holding and positioning the damper 40. The holding groove 321 (and holding groove 331) is further provided with an inward inclined wall 322 (and inward inclined wall 332) which is used for guiding the damper 40 to be positioned in the holding grooves 321 and 331. Furthermore, the end of each supporting plates 32 and 33 is against the base plate 20 so that the both supporting plates 32 and 33 are slight deformed and lifted up. In this time, the elastic member 34 provides a downward force on the pressing plate 31, thus the gap between the pressing plate 31 and the supporting plates 32, 33 will be slight decreased to allow the pressing plate 31 to press firmly on the damper 40 and keep the damper 40 in the holding grooves 321 and 331. The damper 40 is provided with a circular plate 42 for being accommodated in the holding grooves 321 and 331. The damper 40 is further provided with a neck part 401 below the circular plate 42 and a central hole 41 on its lower surface for engaging with the camshaft M1. The neck part 401 passes through the central hole 201 in assembling and is disposed between the supporting plates 32, 33. The circular plate 42 has an inward inclined slope 421 at its lower peripheral surface. The inward inclined slope 421 will be associated with the inward inclined walls 322 and 332 to guide the circular plate 42 in the holding grooves 321 and 331. The pressing plate 31 of the holding plate 30 presses against the circular plate 42 of the damper 40 and then firmly hold the damper 40 in the holding grooves 321 and 331. In this time, the camshaft M1 of the spindle motor M could engage into the central hole 41 of the damper 40 when the spindle motor M lifts up.

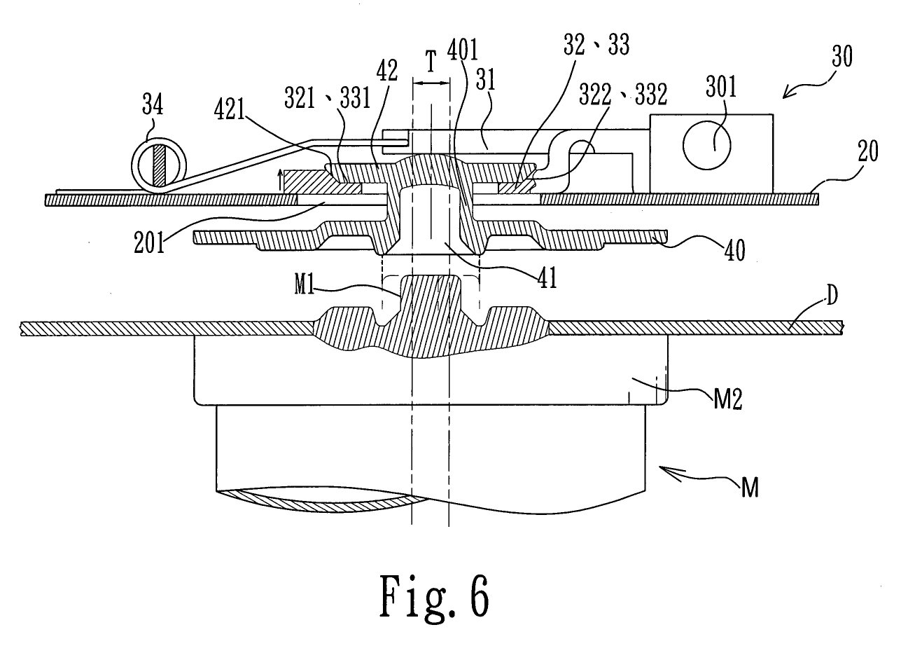

Now please refer to FIG. 6. FIG. 6 is a schematic drawing showing the present apparatus in which a disc has been loaded on the turntable but has not yet been clamped by the apparatus. When no disc is loaded, the supporting plates 32 and 33 is slight deformed due to against on the base plate 20 around the central hole 201 and thus the gap between the pressing plate 31 and the supporting plates 32 and 33 is slight decreased. In this time, the elastic member 34 still remains to press against the pressing plate 31 to press firmly on the pressing plate 31 and keep damper 40 in position. Therefore, if disc D is not clamped between the damper 40 and the turntable M2, the damper 40 is positioned in the holding grooves 32 and 33 and is not movable. Thus in assembling the spindle motor M, the tolerance generated by the deviation of the damper 40 could be ignored. As such, the tolerance T in assembling the spindle motor M is increased and the accuracy required in assembling the spindle motor is therefore relaxed, thus the cost and time required to assembly are reduced.

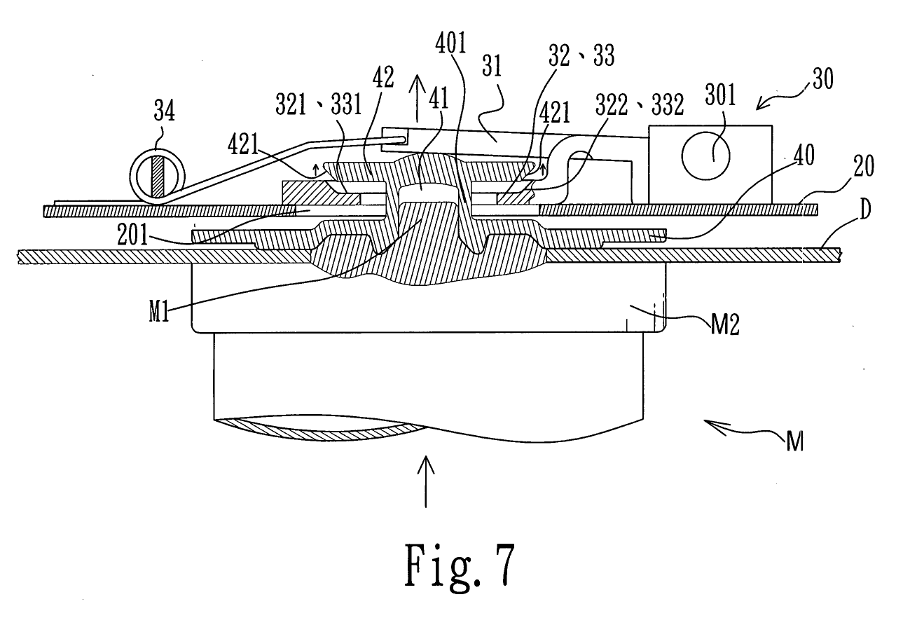

Next please refer to FIG. 7. FIG. 7 is a schematic drawing showing the present apparatus in which a disc has been loaded on the turntable and clamped by the apparatus. When a disc-loading mechanism (not shown in the Figure) loads the disc D on the turntable M2 which is positioned above the spindle motor M, or the disc D is directly put on the turntable M2, the spindle motor M lifts up and then the turntable M2 lifts the disc D up, which in turn lifts the damper 40 up. In this time, the pressing plate 31 pressing on the damper 40 is also lifted un via the spinning axial 301 of the holding plate 30 to allow circular plate 42 of the damper 40 leaving the holding grooves 321 and 331. Since the outer diameter of the neck part 401 of the damper 40 is less than the inner diameter of the central hole 201 and also less than the distance between the two supporting plates 32 and 33, the damper 40 would be in the position that the camshaft M1 inserts accurately into the central hole 41. In this time, since the pressing plate 31 keeps pressing on the damper 40 due to the downward force provided by the elastic member 34, the damper 40 keeps pressing the disc D on the turntable M2 to allow the disc spinning with the rotation of the turntable M2 and then the optical pick-up unit read the information recorded on the disc D.

Now please refer to FIG. 7 again. When the disc D is unloaded, the spindle motor M lowers down to its original position to allow the camshaft M1 releasing from the central hole 41 of the damper 40 and the damper 40 leaves the turntable M2. In this time, the damper 40 would be located in the holding grooves 321 and 331 due to that the inward inclined slope 421 of the circular plate 42 is guided by the inward inclined walls 322 and 332 of the holding grooves 321 and 331. Thus the damper 40 would be positioned and held in the holding grooves 321 and 331 without moving. Therefore if the spindle motor M lifts up again, the camshaft M1 would engage accurately into the central hole 41 of the damper 40.

Moreover, when the damper 40 is positioned in the holding grooves 321 and 331, the pressing plate 31 would keep pressing on the damper 40 through the stress provided by the elastic member 34 to hold the damper 40 in position without shaking.

In summary from the above, according to the present apparatus for positioning a damper of an optical disc device, it would keep holding the damper 40 in the same position if no disc is clamped on the turntable, which could avoid the damper attack the supporting plate and would not result noise due to the external shaking. Furthermore, during assembling the spindle motor M, the tolerance generated by the deviation of the damper 40 could be ignored and thus should not be considered. As such, the margin T in assembling the spindle motor M is increased and thus the cost and time required to assembly are reduced.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. An apparatus for positioning a damper of an optical disc device, the apparatus is installed above a spindle motor and comprises:
a base plate, on which a hole positioned above the spindle motor is provided;
a positioning plate, one end of which is pivoted on the base plate, the other end of the holding plate is extendedly provided with a pressing plate and a pair of flexible supporting plates parallel to each other, the supporting plates are each provided with a holding groove, wherein the supporting plates are against the surface of the base plate and the holding groove is located just above the hole of the base plate;
an elastic member, one end of which is fixed on the base plate and other end presses against the pressing plate to provide a downward force on it; and
a clamper, which is disposed through the hole of the base plate and is provided with a circular plate;
wherein the circular plate is pressed by the pressing plate and held in the holding grooves when no disc is clamped therein.

2. The apparatus for positioning a damper according to claim 1, wherein the damper is further provided with a neck part below the circular plate.

3. The apparatus for positioning a damper according to claim 1, wherein the holding grooves are further provided with an inward inclined wall which corresponds to an inward inclined slope provided at a lower peripheral surface of the circular plate.

4. The apparatus for positioning a damper according to claim 1, wherein the damper is further provided with a central hole and the spindle motor includes a camshaft so that the camshaft is engaged into the central hole when the spindle motor lifts up.

5. The apparatus for positioning a damper according to claim 1, wherein there is a gap between the pressing plate and the supporting plates.

6. The apparatus for positioning a damper according to claim 1, wherein the pressing plate is extended horizontally and the supporting plates are horizontally downward extended slight lower than the pressing plate.

7. The apparatus for positioning a damper according to claim 1, wherein the elastic member is a torsion spring.
